(19) United States
(12) Patent Application Publication
(10) Pub. No.: US 2008/0206647 A1
(43) Pub. Date: Aug. 28, 2008

(54) Ethylene oxide copolymer, polymer composition, and lithium secondary battery

(75) Inventors: Hiromoto Katsuyama, Osaka (JP); Kazuo Takei, Osaka (JP); Taketo Toba, Takarazuka-shi (JP)

Correspondence Address: HARNESS, DICKEY & PIERCE, P.L.C., P.O. BOX 8910, RESTON, VA, 20195, US

(73) Assignee: Nippon Shokubai Co., Ltd.

(21) Appl. No.: 12/071,233

(22) Filed: Feb. 19, 2008

(30) Foreign Application Priority Data
Feb. 21, 2007 (JP) 2007-41383
Feb. 5, 2008 (JP) 2008-25583

(51) Int. Cl. H01M 6/18; C08G 65/04; C08K 5/09

(52) U.S. Cl. 429/317; 528/421; 524/394

(57) ABSTRACT

An ethylene oxide copolymer of the present invention has a crystallization temperature of not more than 20° C. and a glass transition temperature of not more than −64° C. This makes it possible to provide an ethylene oxide copolymer in which increase in the glass transition temperature is small even when metal salt is added, and a polymer composition including the ethylene oxide copolymer.

This Nonprovisional application claims priority under 35 U.S.C. §119(a) on Patent Application No. 41383/2007 filed in Japan on Feb. 21, 2007, and Patent Application No. 025583/2008 filed in Japan on Feb. 5, 2008, the entire contents of which are hereby incorporated by reference.

### FIELD OF THE INVENTION

The present invention relates to an ethylene oxide copolymer having a specific crystallization temperature and glass transition temperature, which makes it possible to restrain increase in the glass transition temperature caused by addition of a metal salt.

### BACKGROUND OF THE INVENTION

Conventionally, an ethylene oxide copolymer is used as a polymer material not only for a polyurethane resin such as an adhesive, a coating material, a sealing agent, an elastomer, a floor finish, but also for various purposes such as a hard, flexible, or semihard polyurethane resin, a surfactant, a sanitary product, a deinking agent, a lubricant oil, a hydraulic oil, a polymer electrolyte (for example, see Nonpatent Document 1).

When the ethylene oxide copolymer is used for these purposes, in order that a necessary property according to each purpose can be brought out, generally, a molecular weight, a copolymer composition, and the like of the polymer are optimized and, in addition, various additives are added so that the polymer is functionalized. There are wide varieties of the additives, but some additives interact with the polymer and may cause property changes of the polymer in addition to the intended functionalization. Especially, there has been known a method of adding a metal salt of an organic acid to a polymer in order to increase toughness (for example, see Patent Documents 1 and 2).

However, with the arrangements of Patent Documents 1 and 2, unfortunately, it is difficult to design materials for a polymer and its composition. More specifically, when a metal salt is added to an ethylene oxide copolymer for preventing electrification, a glass transition temperature of the composition becomes higher than that of the polymer, with the result that changes in physical properties such as viscosity or mechanical strength are caused.

[Nonpatent Document 1] Manta SHIBATA, Masahiro SAITOH, and Shinichi AKIMOTO, “Alkylene Oxide Polymer—Production Method, Property, and Usage—”, published by Kaibundo Publishing Co., Ltd., on Nov. 20, 1990, page 25 to 128

[Patent Document 1] Japanese Unexamined Patent Publication, Tokukai, No. 2003-73537 (published on Mar. 12, 2003)

[Patent Document 2] Japanese Unexamined Patent Publication, Tokukaihei, No. 7-206936 (published on Aug. 8, 1995)

### SUMMARY OF THE INVENTION

The present invention is accomplished in view of the above problems. An object of the present invention is to attain (i) an ethylene oxide copolymer in which increase in a glass transition temperature is small even when a metal salt is added thereto, (ii) a polymer composition including the copolymer, and (iii) a lithium secondary battery including the polymer composition.

The inventors of the present invention diligently studied in order to achieve the above object. In the study process, the inventors considered that if interaction between an ethylene oxide copolymer and metal ions was weakened, increase in its glass transition temperature after a metal salt was added could be small, and performed various experiments and studies. As a result, the inventors of the present invention found that, when the copolymer is highly hydrophobic, the interaction between the ethylene oxide copolymer and the metal ions is most effectively weakened. Furthermore, the inventors found that a crystallization temperature and a glass transition temperature of an ethylene oxide copolymer to which any metal salt is not yet added have a strong correlation with how much the glass transition temperature of the ethylene oxide copolymer changes after the metal salt is added. The present invention was accomplished based on these findings.

More specifically, in order to achieve the above object, an ethylene oxide copolymer of the present invention has a crystallization temperature of not more than 20° C. and a glass transition temperature of not more than −64° C.

With the arrangement, in order to decrease the crystallization temperature and the glass transition temperature of the ethylene oxide copolymer, ethylene oxide is polymerized in the presence of a hydrophobic monomer. According to a structure originated from the presented monomer which is polymerized with the ethylene oxide (hereinafter referred to as “comonomer”), it is possible to restrain (i) crystallization of the ethylene oxide polymer, which crystallization is originated from ethylene oxide chains, and (ii) interaction between the ethylene oxide copolymer and the metal salt when the metal salt is added. Accordingly, this makes it possible to provide the ethylene oxide copolymer in which increase in the glass transition temperature is small even when the metal salt is added.

It is preferable that the ethylene oxide copolymer have heat of crystallization of not more than 60 mJ/mg.

With this arrangement, the crystallization of the ethylene oxide copolymer, which is originated from the ethylene oxide chains, is further prevented, thereby resulting in that the ethylene oxide copolymer is further restrained to interact with the metal salt when the metal salt is added. This makes it possible to provide the ethylene oxide copolymer in which the increase in the glass transition temperature is smaller even when the metal salt is added.

It is preferable that the ethylene oxide copolymer of the present invention be obtained by polymerizing a monomer composition containing not less than 10 mol % of a comonomer.

Furthermore, it is preferable that the ethylene oxide copolymer of the present invention be a random copolymer whose weight-average molecular weight is in a range of not less than 20,000 but not more than 500,000.

In order to achieve the above object, a polymer composition of the present invention includes the ethylene oxide copolymer of the present invention and a metal salt of an organic acid.

With the above arrangement, since the polymer composition includes the ethylene oxide copolymer of the present invention, a difference between each of the glass transition temperatures of the ethylene oxide copolymer and the polymer composition is small. Accordingly, this makes it possible to easily design a glass transition temperature of the polymer composition on the basis of the glass transition temperature of the ethylene oxide copolymer.

In order to achieve the above object, a lithium secondary battery includes the polymer composition of the present invention.

Conventionally, a polymer electrolyte, which is used for a lithium secondary battery, has been examined as a solid electrolyte having high safety since no inflammable solvent is used. However, its ion conductivity is lower compared with an electrolysis solution in which a solvent is generally used. Therefore, the polymer electrolyte is used only at a higher temperature (not less than 60° C.) than a battery for which a solvent is used.

In order to solve such a problem, various arrangements have been examined. For example, a carbonate solvent is used together with a polymer electrolyte (Japanese Unexamined Patent Publication, Tokukai, No. 2007-35646, and Japanese Unexamined Patent Publication, Tokukai, No. 2006-147279), or a polymer having various particular structures is used (see Advanced Technologies for Polymer Battery II, in page 108 to 126, the editorship of Kiyoshi KANEMURA, published by CMC Publishing Co., Ltd).

When a polymer electrolyte is used with a solvent, its ion conductivity can be effectively improved, and risks such as leak can be reduced. However, because the solvent inherently has inflammability, safety which should be expected for a polymer electrolyte is not taken into consideration.

Also, when a polymer having particular structures is used, ion conductivity can be effectively improved and an applicability as a solid electrolyte can be expected. However, there have been problems such as its specialty in production of the polymer or difficulty in handling the polymer. Therefore, the polymer has not been used for an actual use.

On the contrary, in the lithium secondary battery of the present invention, a polymer is designed without using any particular monomers on the basis of properties of a polymer and its metal salt of the organic acid composition, thereby resulting in that it is not necessary for the battery to be used at a high temperature condition of not less than 60° C., which temperature condition has been considered essential for a conventional battery to work, and moreover, the battery can work at a mild temperature such as 40° C.

In this way, the lithium secondary battery of the present invention includes the ethylene oxide copolymer of the present invention, thereby resulting in that a difference between each of the glass transition temperatures of the ethylene oxide copolymer and the polymer composition is small, and interaction between the ethylene oxide copolymer and the metal salt is restrained. On this account, the lithium secondary battery is excellent in ion conductivity and has a high discharge capacity.

With this configuration, it is not necessary for the battery to be used at the high temperature condition of not less than 60° C., but the battery can work at the mild temperature.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a graph illustrating a relationship between a cycle number and service capacities in batteries produced by using ethylene oxide copolymers obtained in Examples.

### DESCRIPTION OF THE EMBODIMENTS

The following describes an ethylene oxide copolymer (hereinafter sometimes referred to as a copolymer of the present invention). The present invention is not limited to the following description, but may be altered by a skilled person within the scope of the claims. In the Description, a range of “A to B” indicates a range of not less than A but not more than B.

Furthermore, each of properties mentioned in the Description indicates a value measured by methods described in after-mentioned Examples, as long as no explanation is especially provided.

(1) Ethylene Oxide Copolymer

The ethylene oxide copolymer of the present invention has a crystallization temperature of not more than 20° C. and a glass transition temperature of not more than −64° C.

The ethylene oxide copolymer of the present invention has the crystallization temperature of not more than 20° C., more preferably within a range of −20 to 18° C., and particularly preferably within a range of −15 to 15° C.

The crystallization temperature can be adjusted by adjusting a length of an ethylene oxide chain in the copolymer (i.e., molecular weight of the copolymer). That is, with a higher weight ratio of a comonomer, the crystallization temperature can be decreased.

Moreover, the ethylene oxide copolymer of the present invention has the glass transition temperature of not more than −64° C., more preferably within a range of −80 to −64° C., and particularly preferably within a range of −70 to −65° C.

Similarly to the crystallization temperature, the glass transition temperature can be adjusted by adjusting a weight ratio of the ethylene oxide and the comonomer. If a glass transition temperature of a homopolymer of the comonomer included in the copolymer is known in advance, and for example, two different monomers are copolymerized, the glass transition temperature can be calculated according to the following equation:

1/Tg=W_{A}/Tg_{A}+W_{B}/Tg_{B}

(where Tg is a glass transition temperature of a copolymer, Tg_{A} is a glass transition temperature of a homopolymer which is formed of a comonomer A, W_{A} is a weight fraction of the comonomer A in the copolymer, Tg_{B} is a glass transition temperature of a homopolymer formed of a comonomer B, and W_{B} is a weight fraction of the comonomer B in the copolymer. Each of the glass transition temperatures in the equation is an absolute temperature, and W_{A}+W_{B}=1.)

More specifically, for example, in a case where a glass transition temperature of an ethylene oxide (EO) homopolymer is −63° C. and a glass transition temperature of an propylene oxide (PO) homopolymer is −75° C., if a comonomer composition is such that a weight ratio is EO/PO =90/10, then a glass transition temperature of a copolymer is −64.2° C. If the comonomer composition is such that the weight ratio is EO/PO=80/20, then the transition temperature of the copolymer is −65.3° C. Furthermore, if the comonomer composition is such that the weight ratio is EO/PO=70/30, then the glass transition of the copolymer is −66.5° C.

Moreover, in the ethylene oxide copolymer of the present invention, heat of crystallization is preferably not more than 60 mJ/mg, more preferably in a range of 0 to 50 mJ/mg, and particularly preferably in a range of 5 to 40 mJ/mg.

Heat of crystallization is dependent on an amount of crystallized molecular chains. Therefore, an ethylene oxide copolymer not easily crystallizable yields less heat of crystallization. More particularly, if a weight ratio of a comonomer is higher, or a chain length of side chains is longer, then the heat of crystallization can be lower.

When any of the crystallization temperature, the glass transition temperature, and the heat of crystallization exceeds the upper limit of the preferable range thereof, crystallization, which is derived from the ethylene oxide chain, is not sufficiently prevented, so that interaction between the ethylene oxide copolymer and a metal salt is not fully restrained. This results in that increase in a glass transition temperature of an obtained polymer is similar to a conventional ethylene oxide copolymer. Moreover, when any of the crystallization temperature, the glass transition temperature, and the heat of crystallization is less than its lower limit, a number of structures derived from the comonomer become excess, thereby resulting in that an obtained polymer is too hydrophobic. As a result, an affinity between the ethylene oxide copolymer and the metal salt is decreased. If the affinity becomes too low, the metal salt cannot be dissolved in the ethylene oxide copolymer. This results in that advantages of adding the metal salt cannot be obtained.

The ethylene oxide copolymer is exemplified by a copolymer which is obtained by copolymerizing ethylene oxide and a monomer composition including at least one of substituted oxirane compounds having structures represented by the following General Formula (I):

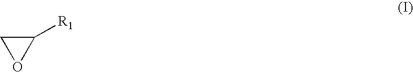

(where R₁ is Rₐ (Rₐ is any one of substituents of an alkyl group, a cycloalkyl group, an aryl group, an aralkyl group, a (meta) acryloyl group, and an alkenyl group, whose carbon number is 1 to 16), or a CH₂—O—Re— Rₐ group (Re has a structure of —(CH₂—CH₂—O)ₚ—, p is an integer selected from 0 to 10).) The Rₐ is more preferable as the R₁ because synthesis or the like is more easily to be performed.

Examples of the substituted oxirane compound represented by the General Formula (I) encompass: propylene oxide, 1,2-epoxybutane, 1,2-epoxyisobutane, 2,3-epoxybutane, 1,2-epoxypentane, 1,2-epoxyhexane, 1,2-epoxyoctane, 1,2-epoxydecane, 1,2-epoxytetradecane, 1,2-epoxyhexadecane, 1,2-epoxyoctadecane, 1,2-epoxy eicosanecyclohexene oxide, styrene oxide, methylglycidyl ether, ethylglycidyl ether, etylenglycolmethylglycidyl ether.

When the substituent R₁ is a substituent having a cross-linking property, examples of the substituted oxirane compound encompass: epoxybutene, 3,4-epoxy-1-pentene, 1,2-epoxy-5,9-cyclododecadiene, 3,4-epoxy-1-vinylcyclohexene, 1,2-epoxy-5-cyclooctene, glycidyl acrylate, glycidyl methacrylate, glycidyl sorbate, glycidyl-4-hexanoate, vinylglycidyl ether, allylglycidyl ether, 4-vinylcyclohexylglycidyl ether, α-terpenyl glycidyl ether, cyclohexenylmethylglycidyl ether, 4-vinylbenzylglycidyl ether, 4-allylbenzylglycidyl ether, allylglycidyl ether, ethyleneglycolallylglycidyl ether, ethyleneglycolvinylglycidyl ether, diethyleneglycolallylglycidyl ether, diethyleneglycolvinylglycidyl ether, triethyleneglycolallylglycidyl ether, triethyleneglycolvinylglycidyl ether, oligoethyleneglycolallylglycidyl ether, oligoethylene glycolvinylglycidyl ether or the like. As described above, each of these oxirane compounds may be used solely or in combination.

A group including silicon such as trymethylsilyl, and an epoxy compound including an alkyl fluoride group are also preferable because the obtained polymer can be the more hydrophobic with a little amount thereof added therein.

It is preferable that propion oxide or butylene oxide be used as the comonomer of the present invention because either of propion oxide and butylene oxide is widely available, its reactivity is easily controlled, and the hydrophobicity of the obtained polymer can be effectively improved therewith. In a case where the polymer is to be cross-linked, it is preferable that allyl glycidyl ether be used from the same reason.

From the viewpoint of breakage of the ethylene oxide chains, the hydrophobic control, the affinity between the ethylene oxide copolymer and the metal salt, and the solubility of the metal salt in the ethylene oxide copolymer, an amount of the comonomer to be used is preferably in a range of 1 to 30 mol % in an amount of all monomers to be used for polymerization, more preferably in a range of 5 to 28 mol %, and particularly preferably in a range of 10 to 20 mol %. An amount of cross-linking monomers is not especially limited, but may be arranged so that necessary properties are obtained. Furthermore, a random copolymer is preferable in order to effectively break the ethylene oxide chains by the comonomers to be copolymerized.

It is more preferable that the ethylene oxide copolymer be a copolymer which is obtained by copolymerizing ethylene oxide, butylene oxide, and allylglycidyl ether.

The monomer composition may include not only ethylene oxide and the substituted oxirane compound, but also other monomers. In order to effectively improve the hydrophobicity of the obtained copolymer, it is more preferable that alkylene oxide such as propylene oxide, butylene oxide, 1,2-epoxypentane, or 1,2-epoxyhexane be used as the substituted oxirane compound.

Among the copolymers, especially in a case where the copolymer is used for a battery, a copolymer is preferable which is prepared by copolymerizing (i) at least one comonomer selected from the group consisting of propylene oxide, butylene oxide, and allylglycidyl ether, and (ii) ethylene oxide, from the viewpoint of better versatility and polymerization of monomers.

Considering crystallization originated from the chain formation of ethylene oxide, a lower molecular weight of the ethylene oxide copolymer can decrease the crystallization temperature, the glass transition temperature, and the heat of crystallization. However, in order to take advantage of its properties as the ethylene oxide copolymer, weight-average molecular weight is preferably not less than five thousands, more preferably in a range of ten thousands to one million, and particularly preferably in a range of twenty thousands to five hundred thousands. When the weight-average molecular weight exceeds the upper limit of the preferable range, it becomes more difficult to handle the copolymer because of its high viscosity, regardless of whether the copolymer is in a bulk form or solution.

A method of the present invention for producing an ethylene oxide copolymer is not especially limited, and may be a conventional method in which an appropriate polymerization catalyst and polymerization solvent is used, so that an intended copolymer is obtained by ring-opening polymerization of the oxirane monomer.

The polymerization catalyst is not especially limited, and its preferable examples encompass: alkaline catalysts such as sodium hydroxide, potassium hydroxide, potassium alchoholate, sodium alchoholate, potassium carbonate, and sodium carbonate; metals such as metallic potassium, metallic sodium, and the like; organic aluminum catalysts; organozinc catalysts; and the like.

As the polymerization solvent, an organic solvent, which includes no active hydrogen such as a hydroxyl group, is preferably used. Examples of organic solvent encompass: an aromatic hydrocarbon solvent such as benzene, toluene, xylene, and ethylbenzene; an aliphatic hydrocarbon solvent such as heptane, octane, n-hexane, n-pentane, and 2,2,4-trimethylpentane; a cycloaliphatic hydrocarbon solvent such as cyclohexane, and methylcyclohexane; an ether solvent such as diethyl ether, dibutyl ether, and methylbutyl ether; an ethylene glycol dialkyl ether solvent such as dimethoxyethane; a cyclic ether solvent such as THF (tetrahydrofuran), and dioxane. Toluene and xylene are more preferable.

When an ethylene oxide copolymer is produced by using such the polymerization catalyst and polymerization solvent, the ethylene oxide copolymer is produced by performing polymerization with stirring monomer compositions in the solvent. Preferable examples of such polymerization method are a solution polymerization method and a precipitation polymerization method. The solution polymerization method is more preferable because the method is excellent in productivity. Furthermore, especially preferable is a solution polymerization, in which polymerization is performed as gradually supplying a monomer composition (a raw material) in the solution contained in container, from the viewpoint of safety because reaction heat is easily removed.

(2) Polymer Composition

A polymer composition of the present invention includes the ethylene oxide copolymer and the metal salt of the organic acid.

The metal salt of the organic acid is not especially limited, and may be a conventionally-known substance. More particularly, examples of the metal salt of the organic acid are alkali metal salts (Li, Na, K) including a residual acid group such as: carboxylic acids such as acetic acid and trifluoroacetic acid; sulfonic acids such as methanesulfonic acid and trifluoromethane sulfonic acid; and a NH compound, which shows a strong acidic property, such as dicyano triazole, and bis(trifluoromethyl sulfonyl) imide.

Examples of the metal salt of the organic acid encompass: lithium perfluoroalkyl sulfonate such as lithium trifluoromethane sulfonate; lithium salt such as lithium dicyano triazolate, lithium bistrifluoromethyl sulfonium imide, lithium difluorosulfonyl imide, lithium hexafluorophosphate, lithium tetrafluoroborate, and lithium perchlorate: potassium salt such as potassium bistrifluoromethyl sulfonium imide, sodium salt such as sodium acetate, and the other metal salt. Above all, lithium bis(trifluoromethyl sulfonyl) imide, lithium difluorosulfonyl imide, lithium dicyanotriazolate, lithium hexafluorophosphate, lithium tetrafluoroborate, lithium perchlorate, and lithium trifluoromethane sulfonate can be preferably used for a battery. Furthermore, lithium bis(trifluoromethyl sulfonyl) imide, lithium difluorosulfonyl imide, and lithium dicyanotriazolate are particularly preferably usable.

The polymer composition contains the ethylene oxide copolymer preferably in a range of 50 to 99% by weight, more preferably in a range of 60 to 95% by weight, and particularly preferably in a range of 70 to 90% by weight. Also, the polymer composition contains the metal salt of the organic acid preferably in a range of 1 to 50% by weight, more preferably in a range of 5 to 40% by weight, and particularly preferably in a range of 10 to 30% by weight.

A method for producing the polymer composition is not especially limited. For example, as described in after-mentioned Examples, the method may include dissolving the ethylene oxide copolymer and the metal salt of the organic acid into an organic solvent, and thereafter removing the organic solvent. In the method, in a case where the ethylene oxide copolymer includes a reactive substituent such as an ally group, cross-linking reaction may be performed after the metal salt of the organic acid is added to the ethylene oxide copolymer.

The cross-linking reaction may be performed, for example, by exposing the polymer composition to UV irradiation after an optical radical polymer initiator is added.

The ethylene oxide copolymer or the polymer composition of the present invention can be preferably used as a polymer material for a wide variety of purposes such as a polyurethane resin which is used for an adhesive, a coating material, a sealing agent, an elastomer, or a floor finish; a hard, flexible, or semihard polyurethane resin; and furthermore, a surfactant, an agent for preventing electrification, sanitary products, a deinking agent, a lubricant oil, a hydraulic oil, or a polymer electrolyte. Note that applications of the ethylene oxide copolymer or the polymer composition of the present invention are not limited thereto.

To put it differently, as has been already described, an ethylene oxide copolymer of the present invention is at least one selected from an adhesive, a coating material, a sealing agent, an elastomer, a floor finish, a surfactant, a deinking agent, a lubricant oil, a hydraulic oil, an agent for preventing electrification, or an electrolyte (hereinafter referred to as “an adhesive or the like”), which includes the ethylene oxide copolymer whose crystallization temperature is not more than 20° C., and whose glass transition temperature is not more than −64° C. With the arrangement, even if the metal salt is included, change in the glass transition temperature is small from that of an ethylene oxide copolymer to which the metal salt is not yet added. This makes it possible to easily design a glass transition temperature of an adhesive or the like on the basis of the glass transition temperature of the ethylene oxide copolymer.

It is preferable that the adhesive or the like have heat of crystallization of not more than 60 mJ/mg. The arrangement makes it possible to more accurately design the glass transition temperature of the adhesive or the like on the basis of the glass transition temperature of the ethylene oxide copolymer.

Furthermore, to put it differently, a polymer composition of the present invention is an adhesive or the like which includes the ethylene oxide copolymer of the present invention and the metal salt of the organic acid.

(3) Lithium Secondary Battery

A lithium secondary battery of the present invention mainly is constituted of an electrolyte, a positive electrode, and a negative electrode, which lithium secondary battery includes the polymer composition. More particularly, in the lithium secondary battery of the present invention, at least any one of the electrolyte, a positive electrode, and a negative electrode includes the polymer composition. More preferably, the electrolyte includes the polymer composition.

The lithium secondary battery of the present invention can be produced, for example, by laminating the negative electrode, the electrolyte, and the positive electrode in this order.

[Positive Electrode]

The positive electrode, for example, can be produced as follows: (i) materials for the positive electrode are dissolved and dispersed in a solvent so as to be a slurry, (ii) the obtained slurry is applied to a current collector, and is then dried and molded by pressure.

Materials other than the polymer composition such as a cathode active material, a conductive material, and a solvent are used in producing the positive electrode. The cathode active material is exemplified by lithium-manganese composite oxide, lithium cobalt oxide, vanadium pentoxide, olivine iron phosphate, polyacetylene, polypyrene, polyaniline, polyphenylene, polyphenylene sulfide, polyphenylene oxide, polypyrrole, polyfuran, and polyazulene.

A carbon material such as ketchen black, acethylene black, or graphite can be used for the conductive material. A positive composition can be obtained even when the polymer composition, the cathode active material, and the conductive material are kneaded without any solvent, but such a positive composition can be easily obtained if a solvent is used.

Such a solvent can be an aromatic hydrocarbon compound such as toluene, or a polar compound such as acetonitrile, acetone, or tetrahydrofuran, which does not include active hydrogen.

A weight ratio of an ethylene oxide copolymer in the slurry made of the above materials is preferably 15 to 60% by weight with respect to the slurry, more preferably 20 to 55% by weight, and furthermore preferably 25 to 50% by weight.

It is not preferable that the weight ratio of the ethylene oxide copolymer be lower than the above range because its productivity enormously decreases. On the other hand, when the weight ratio is greater than the above range, its viscosity becomes higher and it is difficult to mix and stir the materials. This may cause the cathode active material and the conductive material to be unevenly dispersed.

The polymer composition contains the metal salt of the organic acid such that a molar ratio (O/Li) of oxygen atoms in the ethylene oxide copolymer and lithium atoms in the organic metal salt is preferably 1 to 36, more preferably 3 to 33, and further preferably 6 to 30.

When the content of the organic acid metal is less than the above range, performance as a battery may become low because ion conductivity decreases. On the other hand, when the content of the organic metal salt is more than the above range, even if the organic metal salt is further added, further effect to improve the ion conductivity cannot be obtained and economical efficiency may be decreased.

Content of the cathode active material is preferably 0.1 to 50 times by weight of the ethylene oxide copolymer, more preferably 0.3 to 20 times, and further preferably 0.5 to 10 times. When the cathode active material is contained less than the above range, the positive electrode may not fully work. On the other hand, it may be difficult to form the positive electrode material when the cathode active material is contained more than the range.

Content of the conductive material is preferably 0.1 to 20% by weight with respect to the cathode active material, more preferably 1 to 15% by weight. When the conductive material is contained less than the range, performance of the positive electrode may not be brought out because conductivity of the positive electrode is insufficient. On the other hand, it may be difficult to form the positive electrode material when the conductive material is contained more than the range.

In this way, the positive electrode can be produced such that the prepared positive composition slurry is applied to the current collector, and is then dried and molded by pressure. The current collector can be made of a metal foil such as an aluminum foil.

[Electrolyte]

It is preferable that a cross-linking body of the polymer composition be used in a film state for the electrolyte so that a short circuit between the positive electrode and the negative electrode can be prevented.

A method for producing the film is exemplified by (i) a method in which a polymer and an organic acid lithium salt are kneaded and extruded into a thin-film form, and then cross-linked by utilizing reactivity of the polymer, or (ii) a method in which a polymer and an organic acid lithium salt are dissolved in a solvent, then applied to a sheet such as a Teflon (registered trademark), and dried so as to be a film, after which the obtained film is cross-linked.

An aromatic hydrocarbon compound such as toluene, or a polar compound such as acetonitrile, acetone, or tetrahydrofuran, which does not include active hydrogen, can be used as such a solvent.

The polymer composition contains the organic metal salt such that a molar ratio (O/Li) of oxygen atoms in the ethylene oxide copolymer and lithium atoms in the organic metal salt is preferably 1 to 36, more preferably 3 to 33, and further preferably 6 to 30.

When the organic metal salt is contained less than the above range, performance as a battery may become low because ion conductivity decreases. On the other hand, when the metal salt of the organic acid is contained more than the range, even if the organic metal salt is further added, further effect to improve the ion conductivity cannot be obtained and economical efficiency can be decreased.

In the process for producing the electrolyte film, it is possible to add microparticles such as an Aerosil (registered trademark) to the electrolyte film so that the electrolyte film is improved in property such as strength or the like which contributes to easy handling of the electrolyte film.

[Negative Electrode]

Examples of the negative electrode material encompass: compound lamination in which lithium is absorbed between layers of graphite or carbon; lithium metal; lithium-lead alloy; lithium-silicon alloy; lithium-zinc alloy; an artificial graphite such as graphite or mesocarbon microbead; or a composition in which lithium such as lithium titanate is absorbed in a crystal structure. The negative electrode material may be a diaphragm of an ion electrode of a positive ion such as alkali metal ion, Cu ion, Ca ion, or Mg ion.

As described above, the ethylene oxide copolymer of the present invention has the crystallization temperature of not more than 20° C. and the glass transition temperature of not more than −64° C.

This makes it possible to provide an ethylene oxide copolymer in which increase in the glass transition temperature due to the addition of the metal salt thereto is small.

As described above, the polymer composition of the present invention includes the ethylene oxide copolymer and the metal salt of the organic acid.

This makes it possible to easily design a glass transition temperature of the polymer composition based on the glass transition temperature of the ethylene oxide copolymer.

As described above, the lithium secondary battery of the present invention includes the polymer composition of the present invention.

This allows the lithium secondary battery to work at a mild temperature.

### EXAMPLES

The present invention is described in more details in reference to Examples, to which the present invention is not limited. In the followings, “parts by weight” is sometimes simply referred to as “parts”, “hour” as “h”, and “litter” as “L”, for convenience. Also, “weight” is sometimes referred to as “wt” (for example, “% by weight” is referred to as “wt %”, and “weight/weight” as “wt/wt”).

Explained below are pretreatment for materials to be used and conditions for each measurement in the following polymerization examples, Examples, and Comparison Examples. As for each of reaction mixtures which are obtained in Examples 1 through 4 and Comparison Examples 1 through 7, the following evaluations and measurements were performed. These results are illustrated in Tables 1 and 2. Table 1 also illustrates weight-average molecular weight (Mw) and molecular weight distribution (Mw/Mn) of polymers contained in each reaction mixture.

[Dehydration Treatment by Molecular Sieve]

To raw material monomers, solvent and the like to be dried, 10 wt % of a molecular sieve (made by Union Showa K.K., product name: Molecular Sieve (type: 4A 1.6)) were added. Then, the surrounding space of the raw material monomers, solvent and the like was replaced with nitrogen. Then, the raw material monomers, solvent and the like were then left to stand at a room temperature for 12 h ours or longer.

[Measurement of Weight-Average Molecular Weight (Mw) and Molecular Weight Distribution (Mw/Mn)]

A reaction mixture (containing an ethylene oxide copolymer), which was obtained after the reaction, was dissolved in a predetermined solvent, and its weight-average molecular weight (Mw) and molecular weight distribution (Mw/Mn) were measured by using a GPC device (made by Tosoh Corporation, product name: HLC-8220 GPC). With the GPC device, analytical curve was prepared by using a standard molecular weight sample of polyethylene oxide.

[Thermal Analysis: Glass Transition Temperature, Crystallization Temperature, Heat of Crystallization, and Melting Point]

A glass transition temperature, a crystallization temperature, and heat of crystallization of the polymer were measured by using a differential thermal analyzer at the following temperature patterns. A sample of the ethylene oxide copolymer was prepared such that the obtained reaction mixture was dried at 80° C. for 2 hours by a reduced-pressure drier so that volatile matter contents in the reaction mixture was removed.

Temperature Pattern: (i) The polymer was rapidly heated to 100° C. in an analyzer (produced by Seiko Instruments Inc., product name: Thermal Analyzer (SSC 5220H System)) so as to melt down. (ii) The polymer was then cooled rapidly to −150° C. so as to be crystallized. (iii) The crystallized polymer was heated at a heating rate of 5° C./min to 100° C. so that a melting point was obtained from a melting behavior of crystal while the temperature was increasing. (iv) Furthermore, the polymer was rapidly at a cooling rate of 5° C./min to −20° C. so that a crystallization temperature was obtained from an exothermic peak accompanying the crystallization while the temperature was cooled down.

[Evaluation of Battery]

Battery evaluations were performed in a circumstance where a dew point was controlled to be not more than −45° C., if there is not any note especially.

(1) Positive Electrode Forming Process

(i) 12.5 parts of the ethylene oxide copolymer was added in a solution in which 2.6 parts of lithium bis(trifluoromethyl sulfonyl) imide was dissolved in 58 parts of acetonitrile in a closed container, and stirred well so as to obtain a solution in which the polymer was evenly dispersed.

(ii) 27 parts of V205/ketchen black (V₂O₅ is made by Shinko Chemical Co., Ltd., and ketchen black is made by Lion Corporation, V205/ketchen black=95 wt %/5 wt %) was added to the obtained solution in (i), and mixed and dispersed by a homo mixer so as to obtain a slurry of a positive composition, the resulting slurry was filtered by a press filter having 150-mesh metal gauze and defoamed. Thus obtained slurry was then applied to a current collector (made by InteliCoat Technologies, Inc., carbon-coated Aluminum foil (width: 202 mm with a 6 mm uncoated edge)).

(iii) The slurry was dried for 30 minutes at 60° C. by using a reduced-pressure drier, and was then molded by a bench press for 5 minutes at 60° C. and 30 MPa.

(2) Polyelectrolyte Film (SPE) Forming Process

(i) 0.1 parts of ESACURE KTO 46 (made by Sartomer Company, Inc.) was added in a solution in which 2.5 parts of lithium bis(trifluoromethyl sulfonyl) imide and 0.05 parts of Yoshinox BB (product name, made by API Corporation) are dissolved in 18 parts of acetonitrile in a closed container, and stirred well so as to obtain a homogenous solution.

(ii) 10 g of the ethylene oxide copolymer was added to the solution and stirred well while the container was covered by aluminum wheel so that light was shielded. The resulting solution of the polymer was filtered and applied to a Teflon (registered trademark) sheet. Thereafter the resulting solution was dried by the reduced-pressure drier for 30 minutes at 60° C., and was then exposed to UV irradiation so that an SPE film was cross-linked (irradiation intensity: 300 mW/cm², 450W×40 seconds, at room temperature to 60° C.).

(3) Cell Assembling Process

(i) The polyelectrolyte film and the positive film respectively formed in the process (1) and (2), and a Li foil were punched out by a punch. Here, weight of the cathode current collector in the positive film was measured by a precision balance.

(ii) The Li foil, the SPE, and the positive film were laminated in this order in such a manner that no air was let in between each of layers.

(iii) The resulting laminate was placed in a coin battery and caulked therein by a caulking tool while a lid and a container are pressed together with a spring.

(4) Battery Evaluation

The coin battery was placed in a thermostatic chamber at a temperature of 40° C., and was charged and discharged three times at c/24 and then repeatedly at c/8 with constant current. An amount of charged and discharged current was recorded.

### Example 1

A 1L reactor vessel having a Maxblend Blade (made by Sumitomo Heavy Industries, Ltd.) and a filling opening was washed with a solvent, and were then dried by heat. Then, air in the reactor vessel was replaced with nitrogen. Then, (i) 286.5 parts of toluene which was dehydrated with the molecular sieve, and (ii) 0.54 parts of t-butoxy potassium (20 wt % of tetrahydrofuran (THF) solution) (375 ppm for a total content of monomers) as an initiating reagent were sequentially added to the reactor vessel. Thereafter, the headspace of the reactor vessel was replaced with nitrogen. Pressure was applied with nitrogen until pressure in the reactor became 0.3 MPa, and its temperature was increased by using oil bath while Maxblend blade was spin around for stirring the contents.

When it was observed that the temperature in the reactor vessel was 90° C., ethylene oxide and a monomer composition made of: butylene oxide dehydrated with the molecular sieve; and allyl glycidyl ether oxide dehydrated with the molecular sieve (mixture ratio (wt/wt): butylene oxide/allyl glycidyl ether=15/3) were supplied for 2.5 hours at quantitatively constant rates respectively of 47 parts per hour and 10.3 parts per hour, and were then further supplied for 5 hours at quantitatively constant rates respectively of 23.5 parts per hour and 5.15 parts per hour (total amount of the supplied ethylene oxide: 235 parts, total amount of the supplied monomer composition: 51.5 parts).

During the supply, reaction was performed at a temperature within a range of 100° C. +5° C. while increase in pressure and temperature inside the reactor vessel caused by heat of polymerization was monitored and controlled. After the supply, a blended content in the reactor vessel was left to stand for 5 hours so as to be matured. In this way, a reaction mixture containing an ethylene oxide copolymer (A-1) was obtained.

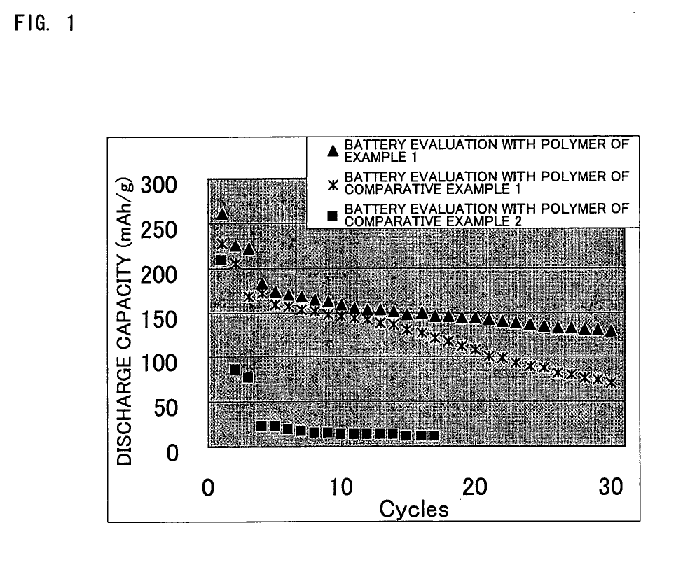

According to the described method, molecular weight measurement and thermal analysis of the ethylene oxide copolymer (A-1) were performed, and its results are as follows: the weight-average molecular weight Mw was 89,000; the molecular weight distribution Mw/Mn was 1.68; the glass transition temperature (Tg) is −65.9° C.; the crystallization temperature (Tc) was 10.6° C.; the heat of crystallization (ΔTc) was 10.5 mJ/mg; and the melting point (Tm) was 30.5° C. A result of battery evaluation is illustrated in FIG. 1.

### Comparative Example 1

Ethylene oxide and a monomer composition of butylene oxide and allyl glycidyl ether (mixture ratio (wt/wt): butylene oxide/allyl glycidyl ether=8/3) were supplied for 2.5 h ours at quantitatively constant rates respectively of 51 parts per hour and 6.3 parts per hour, and were then further supplied for 5 hours at quantitatively constant rates respectively of 25.5 parts per hour and 3.15 parts per hour (total amount of the supplied ethylene oxide: 255 parts, total amount of the supplied monomer composition: 31.5 parts). Other processes were performed in the same way as Example 1, and a reaction mixture containing an ethylene oxide copolymer (A-2) was obtained.

According to the described method, molecular weight measurement and thermal analysis were performed, and its results are as follows: the weight-average molecular weight Mw was 91,000; the molecular weight distribution Mw/Mn was 1.86; the glass transition temperature (Tg) was −62.1° C.; the crystallization temperature (Tc) was 21.1° C.; the heat of crystallization (ΔTc) was 66.8 mJ/mg; and the melting point (Tm) was 36.9° C. A result of battery evaluation is illustrated in FIG.1.

### Comparative Example 2

Ethylene oxide and a monomer composition of butylene oxide and allyl glycidyl ether (mixture ratio (wt/wt): butylene oxide/allyl glycidyl ether=8/3) were supplied according to the following supply condition. Other processes were performed in the same way as Comparative Example 1, and a reaction mixture containing an ethylene oxide copolymer (A-3) was obtained.

According to the described method, molecular weight measurement and thermal analysis were performed, and its results are as follows: the weight-average molecular weight Mw was 104,000; the molecular weight distribution Mw/Mn was 1.70; the glass transition temperature (Tg) was −62.5° C.; the crystallization temperature (Tc) was 20.6° C.; the heat of crystallization (ΔTc) was 93.8 mJ/mg; and the melting point (Tm) was 48.0° C. A result of battery evaluation is illustrated in FIG. 1.

<Supply Condition>

After 30 minutes passed since ethylene oxide was started to be supplied at a rate of 51 parts per hour, a monomer composition (mixture ratio (wt/wt): butylene oxide/allyl glycidyl ether=8/3) was started to be supplied by 7.5 parts per hour. Furthermore, after 2.5 hours passed since the ethylene oxide was started to be supplied, the ethylene oxide and the monomer composition were further supplied for 5 hours respectively at quantitatively constant rates respectively of 25.5 parts per hour and 3.15 parts per hour (total amount of the supplied ethylene oxide: 255 parts, total amount of the supplied monomer composition: 31.5 parts).

### Example 2

The reaction mixture obtained in Example 1 was dried by a reduced-pressure dried at 80° C. for 2 hours so that volatile matter contents in the reaction mixture were removed. Thus, an ethylene oxide copolymer (A-1) was obtained.

Then, 0.98 parts of lithium dicyano triazolate (LiDCTA), 50.00 parts of acetonitrile, and 0.1 parts of optical radial polymer initiator, Irgacure 651 (made by Nagase & Co., Ltd.), were added to 9.02 parts of the obtained ethylene oxide copolymer (A-1), and stirred and dissolved. The resulting mixture solution was applied to a Teflon (registered trademark) sheet by 50 μm in thickness, and was then dried by a reduced-pressure drier at 80° C. for 2 hours so that volatile content in a coating film was removed.

Thereafter, the resulting coating film was exposed to UV irradiation (UV irradiation device: made by Ushio Inc., product name: light source device for baking (URM-100), UV irradiation condition: (output) 450W, (irradiation time) 40 seconds), with the result that a film made of a polymer composition was obtained. Thermal analysis of the obtained film made of the polymer composition was performed, and its result is as follows: the glass transition temperature (Tg) was −51.1° C.; the crystallization temperature (Tc) was −7.5° C.; the heat of crystallization (ΔTc) was 42.7 mJ/mg; and the melting point (Tm) was 18.2° C.

### Comparative Example 3

Instead of using the reaction mixture which was obtained in Example 1, the reaction mixture which was obtained in Comparative Example 1 was used. Other processes were performed in the same way as Example 2, and a film made of a polymer composition was obtained. Thermal analysis of the obtained film made of the polymer composition was performed, and its result is as follows: the glass transition temperature (Tg) was −46.1° C.; the crystallization temperature (Tc) was −1.2° C.; the heat of crystallization (ΔTc) was 81.9 mJ/mg; and the melting point (Tm) was 34.3° C.

### Example 3

The reaction mixture which was obtained in Example 1 was dried by a reduced-pressure drier at 80° C. for 2 hours so that volatile content in the reaction mixture was removed. In this way, an ethylene oxide copolymer (A-1) was obtained.

2.00 parts of lithium bistrifluoromethyl sulfonium imide (LiTFSI), 50.00 parts of acetonitrile, and 0.1 parts of optical radical polymer initiator, Irgacure 651 (made by Nagase & Co., Ltd.), were added to 8.00 parts of the obtained ethylene oxide copolymer (A-1), and were then stirred and dissolved. The resulting mixture solution was applied to a Teflon (registered trademark) sheet by 50 μm in thickness, and then dried by the reduced-pressure drier at 80° C. for 2 hours so that volatile matter contents in a coating film were removed.

Thereafter, the resulting coating film was exposed to UV irradiation (UV irradiation device: made by Ushio Inc., product name: light source device for baking (URM-100), UV irradiation condition: (output) 450W, (irradiation time) 40 seconds), with the result that a film made of a polymer composition was obtained. Thermal analysis of the obtained film made of the polymer composition was performed, and its result is as follows: the glass transition temperature (Tg) was −59.7° C.; the crystallization temperature (Tc) was −23.9° C.; the heat of crystallization (ΔTc) was 9.7 mJ/mg; and the melting point (Tm) was 14.3° C.

### Comparative Example 4

Instead of using the reaction mixture which was obtained in Example 1, the reaction mixture which was obtained in Comparative Example 1 was used. Other processes were performed in the same way as Example 3, and a film made of a polymer composition was obtained. Thermal analysis of the obtained film made of the polymer composition was performed, and its result is as follows: the glass transition temperature (Tg) was −52.2° C.; the crystallization temperature (Tc) was 1.0° C.; the heat of crystallization (ΔTc) was 4.6 mJ/mg; and the melting point (Tm) was 26.8° C.

### Comparative Example 5

Instead of using the reaction mixture which was obtained in Example 1, the reaction mixture which was obtained in Comparative Example 2 was used. Other processes were performed in the same way as Example 3, and a film made of a polymer composition was obtained. Thermal analysis of the obtained film made of the polymer composition was performed, and its result is as follows: the glass transition temperature (Tg) was −45.4° C.; the crystallization temperature (Tc) was −4.8° C.; the heat of crystallization (ΔTc) was 29.6 mJ/mg; and the melting point (Tm) was 40.4° C.

### Example 4

The reaction mixture which was obtained in Example 1 was dried by a reduced-pressure drier at 80° C. for 2 hours so that volatile matter contents in the reaction mixture were removed. Thus, an ethylene oxide copolymer (A-1) was obtained.

Then, 2.17 parts of potassium bistrifluoromethyl sulfonium imide (KTFSI) and 50.00 parts of acetonitrile were added to 7.83 parts of the obtained ethylene oxide copolymer (A-1), and were then stirred and dissolved. The resulting mixture solution was applied to a Teflon (registered trademark) sheet by 50 μm in thickness, and then dried by a reduced-pressure drier at 80° C. for 2 hours so that volatile content in a coating film was removed. Thus, a film made of a polymer composition was obtained. Thermal analysis of the obtained film made of the polymer composition was performed, and its result is as follows: the glass transition temperature (Tg) was −58.3° C; the crystallization temperature (Tc) was −32.7° C.; the heat of crystallization (ΔTc) was 136.0 mJ/mg; and the melting point (Tm) was 39.3° C.

### [Comparative Example 6 ]

Instead of using the reaction mixture which was obtained in Example 1, the reaction mixture which was obtained in Comparative Example 1 was used. Other processes were performed in the same way as Example 4, and a film made of a polymer composition was obtained. Thermal analysis of the obtained film made of the polymer composition was performed, and its result is as follows: the glass transition temperature (Tg) was −48.5° C.; the crystallization temperature (Tc) was −28.4° C.; the heat of crystallization (ΔTc) was 90.7 mJ/mg; and the melting point (Tm) was 39.1° C.

### Comparative Example 7

Instead of using the reaction mixture which was obtained in Example 1, the reaction mixture which was obtained in Comparative Example 2 was used. Other processes were performed in the same way as Example 4, and a film made of a polymer composition was obtained. Thermal analysis of the obtained film made of the polymer composition was performed, and its result is as follows: the glass transition temperature (Tg) was −48.0° C.; the crystallization temperature (Tc) was −23.1° C.; the heat of crystallization (ΔTc) was 117.0 mJ/mg; and the melting point (Tm) was 40.1° C.

### Example 5

The reaction mixture which was obtained in Example 1 was dried by a reduced-pressure drier at 80° C. for 2 hours so that volatile content in the reaction mixture were removed. Thus, an ethylene oxide copolymer (A-1) was obtained.

Then, 1 part of sodium acetate (CH₃COONa) and 50.00 parts of acetonitrile were added to 9 parts of the obtained ethylene oxide copolymer (A-1), and were then stirred and dissolved. The resulting mixture solution was applied to a Teflon (registered trademark) sheet by 50 μm in thickness, and then dried by the reduced-pressure drier at 80° C. for 2 hours so that volatile content in a coating film were removed. Thus, a film made of a polymer composition was obtained. Thermal analysis of the obtained film made of the polymer composition was performed, and its result is as follows: the glass transition temperature (Tg) was −62.2° C.; the crystallization temperature (Tc) was −29.0° C.; the heat of crystallization (ΔTc) was 138.0 mJ/mg; and the melting point (Tm) was 39.1° C.

### Comparative Example 8

Instead of using the reaction mixture which was obtained in Example 1, the reaction mixture which was obtained in Comparative Example 1 was used. Other processes were performed in the same way as Example 5, and a film made of a polymer composition was obtained. Thermal analysis of the obtained film made of the polymer composition was performed, and its result is as follows: the glass transition temperature (Tg) was −57.3° C.; the crystallization temperature (Tc) was −32.8° C.; the heat of crystallization (ΔTc) was 87.3 mJ/mg; and the melting point (Tm) was 39.1° C.

The following Tables 1 and 2 illustrate the above results.

TABLE 1

| | Properties of Ethylene Oxide Copolymers | | | | | |
|---|---|---|---|---|---|---|
| | Tg | Tc | ΔTc | Tm | | |
| | (° C.) | (° C.) | (mJ/mg) | (° C.) | Mw | Mw/Mn |
| Ex. 1 | −65.9 | 10.6 | 10.5 | 30.5 | 89,000 | 1.68 |
| Com. Ex. 1 | −62.1 | 21.1 | 66.8 | 36.9 | 91,000 | 1.86 |
| Com. Ex. 2 | −62.5 | 20.6 | 93.8 | 48 | 104,000 | 1.7 |

Abbreviation:
Ex. stands for “Example”.
Com. Ex. stands for “Comparative Example”.

TABLE 2

| | Ethylene | | | | | | | | |
|---|---|---|---|---|---|---|---|---|---|
| | Oxide | | | | | | | | |
| | Copolymer | | Metal Salt | | Propeties of Composition | | | | Tg |
| | | Tg | of Organic | Cross | Tg | Tc | ΔTc | Tm | Up |
| | Kind | (° C.) | Acid | Linking | (° C.) | (° C.) | (mJ/mg) | (° C.) | (° C.) |
| Ex. 2 | A-1 | −65.9 | LiDCTA | done | −51.1 | −7.5 | 42.7 | 18.2 | 14.8 |
| Com. | A-2 | −62.5 | LiDCTA | done | −46.1 | −1.2 | 81.9 | 34.3 | 16.4 |
| Ex. 3 | | | | | | | | | |
| Ex. 3 | A-1 | −65.9 | LiTFSI | done | −59.7 | −23.9 | 9.7 | 14.3 | 6.2 |
| Com. | A-2 | −62.1 | LiTFSI | done | −52.2 | 1 | 4.6 | 26.8 | 9.9 |
| Ex. 4 | | | | | | | | | |
| Com. | A-3 | −62.5 | LiTFSI | done | −45.4 | −4.8 | 29.6 | 40.4 | 17.1 |
| Ex. 5 | | | | | | | | | |
| Ex. 4 | A-1 | −65.9 | KTFSI | None | −58.3 | −32.7 | 136 | 39.3 | 7.6 |
| Com. | A-2 | −62.1 | KTFSI | None | −48.5 | −28.4 | 90.7 | 39.1 | 13.6 |
| Ex. 6 | | | | | | | | | |
| Com. | A-3 | −62.5 | KTFSI | None | −48 | −23.1 | 117 | 40.1 | 14.5 |
| Ex. 7 | | | | | | | | | |
| Ex. 5 | A-1 | −65.9 | CH₃COONa | None | −62.2 | −29 | 138 | 39.1 | 3.7 |
| Com. | A-2 | −62.1 | CH₃COONa | None | −57.3 | −32.8 | 87.3 | 39.1 | 4.8 |
| Ex. 8 | | | | | | | | | |

Abbreviation:
Ex. stands for “Example”.
Com. Ex. stands for “Comparative Example”.
“Cross Linking” indicates whether the composition was cross-linked or not.
“Tg Up” indicates how much Tg was increased.

As illustrated in Tables 1 and 2, it was found that in a case where the same metal salt of organic acid was used, Tg increase of the ethylene oxide copolymer (A-1) which was obtained in Example 1 was less than that of each of the ethylene oxide copolymers (A-2) and (A-3) which were obtained respectively in Comparative Examples 2 and 3. Especially, the Tg increase in Example 3 was about ⅓ to ⅗ of each of the Tg increases in Comparative Examples 4 and 5, that is, the Tg increase in Example 3 was about 35 to 60% of each of the Tg increases in Comparative Examples 4 and 5, and the Tg increase in Example 4 was approximately 50% of each of the Tg increases in Comparative Examples 6 and 7.

Generally, in order to produce an ethylene oxide copolymer in which its glass transition temperature decreases by 1° C., it is necessary that copolymerization be performed such that 5 to 10% by weight of comonomer is added to ethylene oxide, and then copolymerized (for example, in a case where polyethylene oxide is copolymerized with propylene oxide, in order to produce a copolymer in which its glass transition temperature decreases by 1° C., it is necessary that copolymerization be performed such that about 10% by weight of propylene oxide is contained in monomers, and then copolymerized).

If only 1° C. of an increase of a glass transition temperature is restrained, it is possible to lower an amount of comonomers to be copolymerized in polymerization. Consequently, as it can be understood from the effect for preventing increase in the glass transition temperature as demonstrated in the Examples, it is possible to highly flexibly design a molecular of the ethylene oxide copolymer of the present invention, and this provides more advantageous effect compared with the conventional ethylene oxide copolymer.

The polymer composition of Example 1 can be used as a lubricant oil, a hydraulic oil, and an electrolyte, and the film made of the polymer composition of Examples 2 through 5 can be used as a sheet for preventing electrification, an electrolyte, an adhesive, a coating material, a sealing agent, an elastomer, or a floor finish.

For the above purposes, adhesiveness, cohesion power, and resistance (conductivity) are important properties. In this regard, temperature dependency of each of properties (adhesiveness, cohesion power, and resistance) decreases because the glass transition temperature decreases. On this account, it can be expected that those properties be brought out in a wide temperature range regardless of seasons.

Moreover, as illustrated in FIG. 1, a battery produced by using the ethylene oxide copolymer of Example 1 showed high discharge capacity compared with batteries which were produced by using the ethylene oxide copolymers of Comparative Examples 1 and 2. Particularly, as charge/discharge cycle number increased, it was found that its difference tended to be large.

The present invention is not limited to the description of the examples above, but may be altered by a skilled person within the scope of the claims. An embodiment based on a proper combination of technical means disclosed in different embodiments is encompassed in the technical scope of the present invention.

### INDUSTRIAL APPLICABILITY

The ethylene oxide copolymer of the present invention has a crystallization temperature of not more than 20° C. and a glass transition temperature of not more than −64° C., thereby resulting in that increase in the glass transition temperature is small when metal salt is added. Therefore, the ethylene oxide copolymer of the present invention can be preferably used for an adhesive, a coating material, a sealing agent, an elastomer, a floor finish, a lubricant oil, a hydraulic oil, an electrolyte, or the like.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An ethylene oxide copolymer having a crystallization temperature of not more than 20° C. and a glass transition temperature of not more than −64° C.

2. The ethylene oxide copolymer as set forth in claim 1, wherein heat of crystallization is not more than 60 mJ/mg.

3. The ethylene oxide copolymer as set forth in claim 1, obtained by polymerizing a monomer composition containing not less than 10 mol % of a comonomer.

4. The ethylene oxide copolymer as set forth in claim 2, obtained by polymerizing a monomer composition containing not less than 10 mol % of a comonomer.

5. The ethylene oxide copolymer as set forth in claim 3, being a random copolymer whose weight-average molecular weight is in a range of not less than 20,000 but not more than 500,000.

6. A polymer composition comprising:
an ethylene oxide copolymer having a crystallization temperature of not more than 20° C. and a glass transition temperature of not more than −64° C.; and
a metal salt of an organic acid.

7. The polymer composition as set forth in claim 6, wherein heat of crystallization of the ethylene oxide copolymer is not more than 60 mJ/mg.

8. The polymer composition as set forth in claim 6, wherein the ethylene oxide copolymer is obtained by polymerizing a monomer composition containing not less than 10 mol % of a comonomer.

9. The polymer composition as set forth in claim 8, wherein the ethylene oxide copolymer is a random copolymer whose weight-average molecular weight is in a range of not less than 20,000 but not more than 500,000.

10. A lithium secondary battery comprising:
a polymer composition including an ethylene oxide copolymer and a metal salt of an organic acid,
the ethylene oxide copolymer having a crystallization temperature of not more than 20° C. and a glass transition temperature of not more than −64° C.

11. The lithium secondary battery as set forth in claim 10, wherein the ethylene oxide copolymer has heat of crystallization of not more than 60 mJ/mg.

12. The lithium secondary battery as set forth in claim 10, wherein the ethylene oxide copolymer is obtained by polymerizing a monomer composition containing not less than 10 mol % of a comonomer.

13. The lithium secondary battery as set forth in claim 12, wherein the ethylene oxide copolymer is a random copolymer whose weight-average molecular weight is in a range of not less than 20,000 but not more than 500,000.
